(19) United States
(12) Patent Application Publication
(10) Pub. No.: US 2019/0164208 A1
(43) Pub. Date: May 30, 2019

(54) CATALOG DRIVEN INTERACTIVE CONVERSATIONAL PLATFORM

(71) Applicant: International Business Machines Corporation, Armonk, NY (US)

(72) Inventors: Pankaj Dhoolia, Ghaziabad (IN); Harshit Kumar, Delhi (IN); Sachindra Joshi, Gurgaon (IN); David Nahamoo, Great Neck, NY (US)

(21) Appl. No.: 15/825,181

(22) Filed: Nov. 29, 2017

(51) Int. Cl. G06Q 30/06; G06F 17/30

(52) U.S. Cl. CPC G06Q 30/0627; G06F 17/30654; G06Q 30/0631; G06Q 30/0603

(57) ABSTRACT

A computer receives a conversational input. The computer detects, based on the conversational input, relevant entities and relevant entity values, wherein the relevant entities and relevant entity values correspond to entities and entity values extracted from a catalog. The computer identifies, based on the relevant entities and relevant entity values, one or more matching products or services. The computer displays the one or more matching products or services. The computer assesses one or more attributes of the matching products or services for refinement. The computer provides one or more attribute refinement options based on the assessed one or more attributes. The computer receives user refinement in response to providing the one or more attribute refinement options. The computer receives a product or service selection.

### BACKGROUND

Many businesses offer a catalog or other listing of items or services that they offer, and customers of those businesses can select and buy items or services from such catalog or listing. Some businesses employ conversational “bots” specifically trained for their business, including their catalog or listing of items or services they offer, which can take a user's input and direct the user to an appropriate item or service.

### SUMMARY

Disclosed herein are embodiments of a method, system, and computer program product for using a catalog driven interactive conversational platform. A computer receives a conversational input. The computer detects, based on the conversational input, relevant entities and relevant entity values, wherein the relevant entities and relevant entity values correspond to entities and entity values extracted from a catalog. The computer identifies, based on the relevant entities and relevant entity values, one or more matching products or services. The computer displays the one or more matching products or services. The computer assesses one or more attributes of the matching products or services for refinement. The computer provides one or more attribute refinement options based on the assessed one or more attributes. The computer receives user refinement in response to providing the one or more attribute refinement options. The computer receives a product or service selection.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of an example computer system in accordance with some embodiments of the present disclosure.

FIG. 2 depicts an example method for conversational system initialization, in accordance with embodiments of the present disclosure.

FIG. 3 depicts an example method for assisting a user using a conversational platform, in accordance with embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate generally to sales platforms, and more specifically, to conversational sales platforms. While the present disclosure is not necessarily limited to such applications, various aspects of the disclosure can be appreciated through a discussion of various examples using this context.

Embodiments of the present disclosure include catalog driven interactive conversational platforms. In accordance with embodiments disclosed herein, a conversational platform can process a catalog, which can include a catalog being uploaded by a business and/or a business providing a catalog application programming interface (API) to the conversational platform. The conversational platform can analyze and extract catalog entities from the catalog or the catalog API, including products and/or services for sale and attributes of the products and/or services for sale. The conversational platform can also extract entity values relating to each entity. The conversational platform can enrich these entities and entity values by looking up synonym sets and catalog instances to enhance the entities and attributes used by the conversational platform. The conversational platform can use this catalog or catalog API and its extracted and enriched data in user interactions. The conversational platform can receive a user conversational input, which can include a request for a product or service. The conversational platform can detect relevant entities and entity values to the input. The conversational platform can identify and display matching products and/or services to the user. A user can select a products and/or services at this time, or proceed to refine the products and/or services provided to them. The conversational platform can assess one or more attributes of the matching products and/or services to refine and provide attribute refinement option(s) to the user. The conversational platform can receive the user refinement and using this refinement, identify and display new matches. This can continue until a user selects a product and/or service, declines to refine the products and/or services further, or otherwise terminates the process. In some embodiments, the conversational platform can provide cross-sell and/or up-sell recommendations based on the products and/or services selected and the user's interactions with the conversational platform to entice a user to purchase additional and/or more expensive items than that selected. The conversational platform can receive a final user selection and may facilitate the sale.

The embodiments discussed herein can provide advantages over conventional catalogs and conversational bots. Embodiments provided for herein can allow a business to declare a catalog and start to have ecommerce conversations powered by it without further action required by a business. In some embodiments, a business using the embodiments discussed herein will not need to upload their entire inventory to a conversational platform and can instead use a catalog API allowing the conversational platform to support external inventory lists, spreadsheets, databases, or the like. Additional advantages include that the conversational platform can select attributes for refinement based upon a conversation with a user as it occurs using dynamic data associated with user input and selections. This can result in quicker and/or more effective conversations with a user compared to a knowledge graph based conversation which uses predetermined possible pathways for conversation. Instead, the disclosed embodiments can lead to a conclusion and/or user product or service selection in fewer steps and/or with greater accuracy using the conversational platform's dynamically computed pathways for further conversation, along with associated weighting information.

The aforementioned improvements and/or advantages are example improvements and/or advantages. These improvements and/or advantages are a non-exhaustive list of example advantages. Embodiments of the present disclosure exist which can contain none, some, or all of the aforementioned advantages and/or improvements.

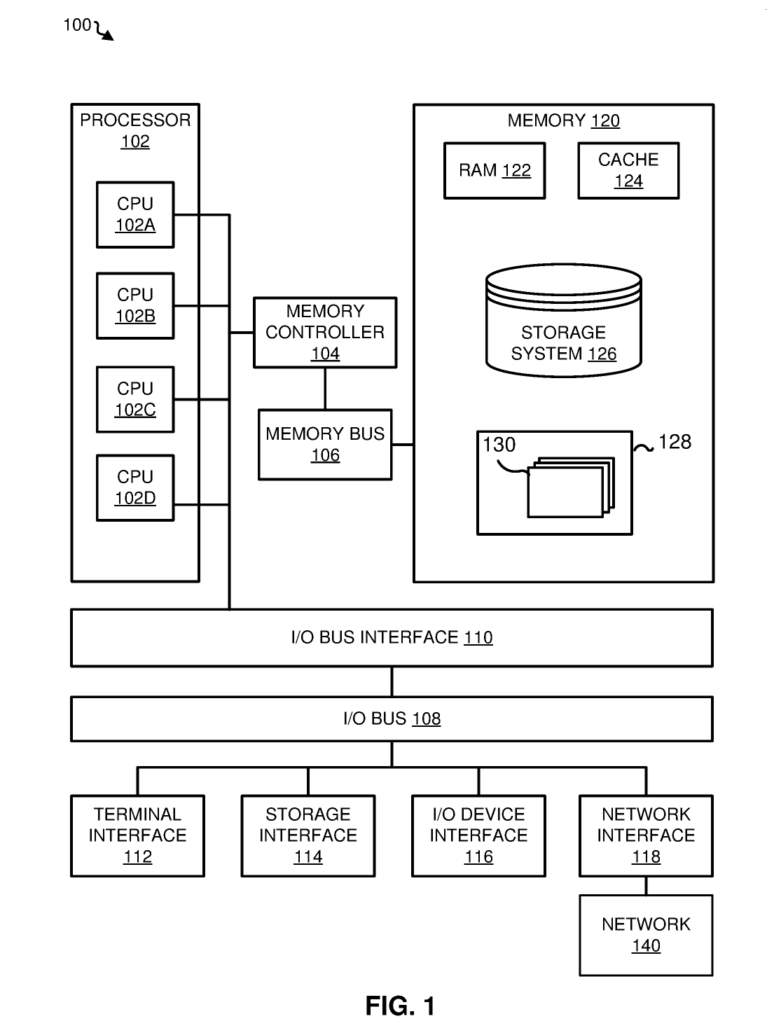

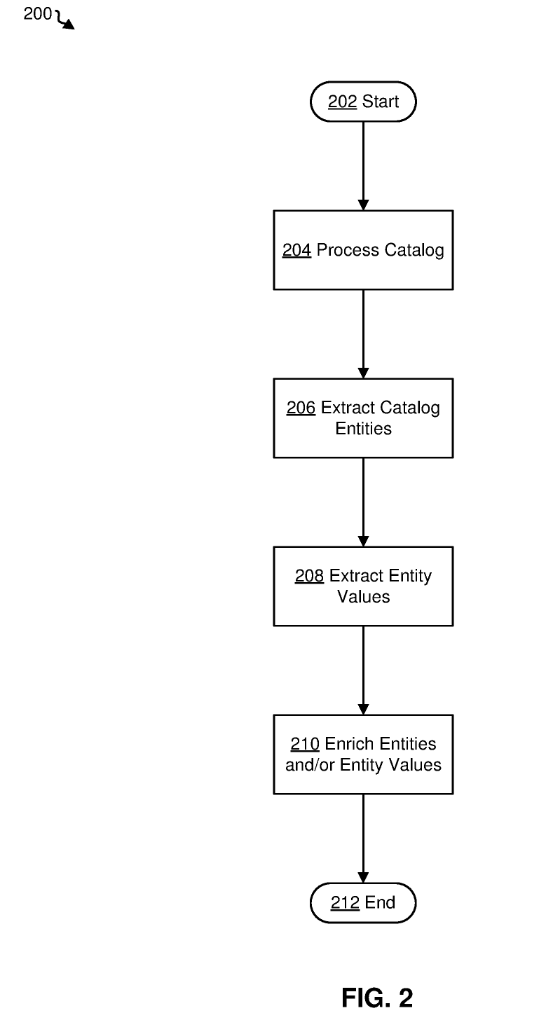

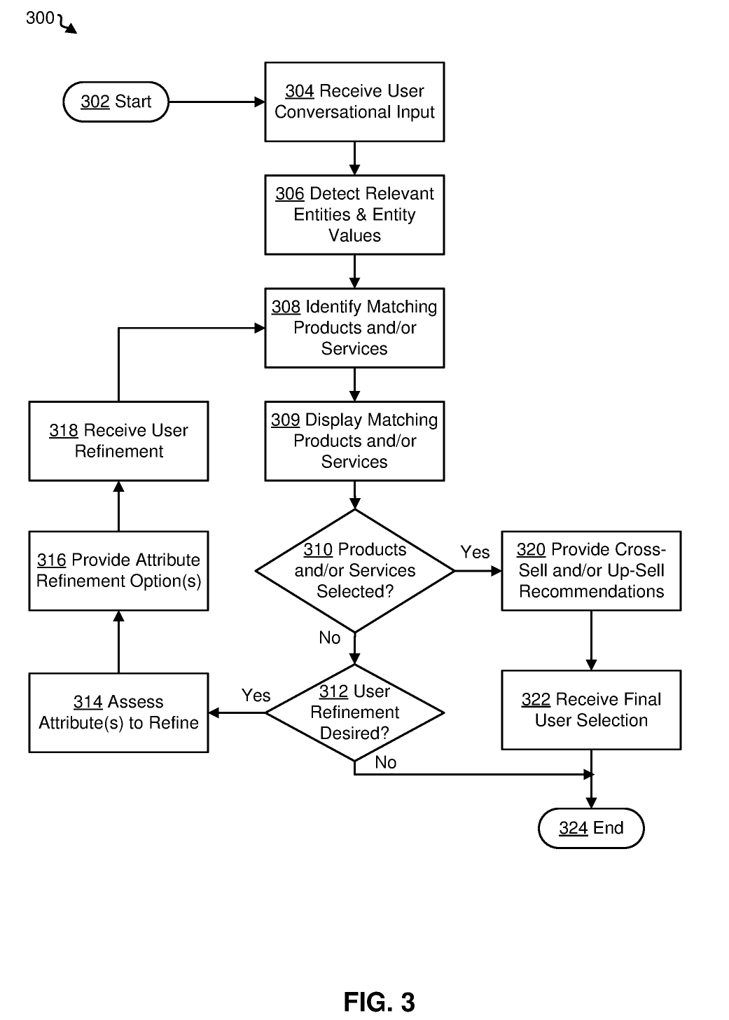

FIG. 1 depicts a high-level block diagram of an example computer system 100 (e.g., a conversational platform device) that can be used in implementing one or more of the methods (such as methods 200 and 300 in accordance with FIGS. 2 and 3, respectively, as described infra), tools, and modules, and any related functions, described herein, in accordance with embodiments of the present disclosure. In some embodiments, the components of the computer system 100 can comprise one or more processors 102, a memory subsystem 120, a terminal interface 112, a storage interface 114, an I/O (Input/Output) device interface 116, and a network interface 118, all of which can be communicatively coupled, directly or indirectly, for inter-component communication via a memory bus 106, an I/O bus 108, and an I/O bus interface unit 110.

The computer system 100 can contain one or more general-purpose programmable central processing units (CPUs) 102A, 102B, 102C, and 102D (four CPUs are shown by way of example and should not be read as limiting to or requiring four CPUs), herein generically referred to as processor 102 or CPU 102. Any or all of the CPUs of CPU 102 can contain multiple processing cores in various embodiments. In some embodiments, the computer system 100 can contain multiple processors typical of a relatively large system; however, in other embodiments the computer system 100 can alternatively be a single CPU system. Each CPU 102 can execute instructions stored in the memory subsystem 120 and can include one or more levels of on-board cache that provide temporary storage of instructions and data for the CPUs 102. The CPUs 102 can be comprised of one or more circuits configured to perform one or more methods consistent with embodiments of the present disclosure. The control of data flow from the processor 102 to the memory subsystem 120 can be facilitated by memory controller 104. The memory controller 104 can be configured to direct data to appropriate locations (e.g., addresses) within the memory subsystem 120.

Memory subsystem 120 can include computer system readable media in the form of volatile memory, such as random-access memory (RAM) 122 or cache memory 124. Computer system 100 can further include other removable/non-removable, volatile/non-volatile computer system storage media. By way of example only, storage system 126 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 120 can include flash memory, e.g., a flash memory stick drive or a flash drive. In some embodiments, the storage system 126 can be replaced by storage area-network (SAN) devices, the cloud, or other devices connected to the computer system 100 via the I/O device interface 116 or a network 140 via the network interface 118. Memory devices can be connected to memory bus 106 by one or more data media interfaces. The memory subsystem 120 can include at least one program product having a set (e.g., at least one) of program modules that are configured to carry out the functions of various embodiments.

Further, one or more memory modules can be included in the storage system 126. For example, one or more DIMMs can be included in the storage system 126 in lieu of or in addition to RAM 122. The one or more memory modules can include their own memory controllers, processors, buses, and any other suitable memory module components.

It is noted that FIG. 1 is intended to depict representative components of an example computer system 100. In some embodiments, however, individual components can have greater or lesser complexity than as represented in FIG. 1, components other than or in addition to those shown in FIG. 1 can be present, and the number, type, and configuration of such components can vary.

One or more programs/utilities 128, each having at least one set of program modules 130 can be stored in memory 120. The programs/utilities 128 can include a hypervisor (also referred to as a virtual machine monitor), one or more operating systems, one or more application programs, other program modules, user interfaces, and program data. Each of the operating systems, one or more application programs, other program modules, and program data or some combination thereof, can include an implementation of a networking environment. In some embodiments, one or more programs/utilities 128, each having at least one set of program modules 130 can be used in implementing one or more of the methods (such as methods 200 and 300 in accordance with FIGS. 2 and 3, respectively, as described infra).

The computer system 100 can interface a variety of peripheral devices, storage devices, and networks (including network 140) through the terminal interface 112, storage interface 114, I/O device interface 116, and network interface 118. For example, I/O device interface 116 can receive input from a user and present information to a user and/or a device interacting with computer system 100.

Although the memory bus 106 is shown in FIG. 1 as a single bus structure providing a direct communication path among the CPUs 102, the memory subsystem 120, and the I/O bus interface 110, the memory bus 106 can, in some embodiments, include multiple different buses or communication paths, which can be arranged in any of various forms, such as point-to-point links in hierarchical, star or web configurations, multiple hierarchical buses, parallel and redundant paths, or any other appropriate type of configuration. Furthermore, while the I/O bus interface 110 and the I/O bus 108 are shown as single respective units, the computer system 100 can, in some embodiments, contain multiple I/O bus interface units 110, multiple I/O buses 108, or both. Further, while multiple I/O interface units are shown, which separate the I/O bus 108 from various communications paths running to the various I/O devices, in other embodiments some or all of the I/O devices can be connected directly to one or more system I/O buses.

In some embodiments, the computer system 100 can be a multi-user mainframe computer system, a single-user system, or a server computer or similar device that has little or no direct user interface, but receives requests from other computer systems (clients). Further, in some embodiments, the computer system 100 can be implemented as a desktop computer, portable computer, laptop or notebook computer, tablet computer, pocket computer, telephone, smart phone, network switches or routers, or any other appropriate type of electronic device.

Referring now to FIG. 2, depicted is an example method 200 for conversational system initialization, in accordance with embodiments of the present disclosure. The following discussion will refer to method 200 being performed by a conversational platform. It is to be understood that the conversational platform can be implemented by (and, thus, method 200 performed by) a computer, a processor, a memory controller, firmware or software running on a computer system, or other component(s) of a computer system. Method 200 can include more or less operations than those depicted. Method 200 can include operations in different orders than those depicted, including operations occurring simultaneously.

Method 200 starts at 202. At 204, the conversational platform processes a catalog. The conversational platform can process a catalog by receiving a catalog uploaded by a business or by a business providing or declaring a catalog application programming interface (API) to the conversational platform. This catalog or catalog API can include various amounts and types of information in various embodiments. In some embodiments, the catalog or catalog API can include product and/or service names, various types and amounts of information about products and/or services, groupings of products and/or services into collections or other groups and/or subgroups, information relating to cross-selling and/or up-selling information, ordered information relating to which questions a conversational platform should inquire of a user in order, product and/or service history, or any other information which could be useful for a providing their products and/or services, including by a conversational platform. Catalogs which are uploaded to the conversational platform can change over time, which could require that the business provide the catalog and/or the updated portions of the catalog to the conversational platform when it changes. For businesses providing a catalog API, the conversational platform can use the catalog API to detect changes and update the conversational platform's information as necessary. A catalog API can be a SQL/NO-SQL data-access, a true RESTful API, an API wrapper representing the web-site as the catalog data-source, or other suitable form of API. In some embodiments, a transforming wrapper may need to be written over the existing catalog API to match the expectations of the conversational platform.

At 206, the conversational platform analyzes and extracts entities from the catalog or the catalog API. The conversational platform analyzes the catalog or catalog API to determine entities to further use in method 200. Entities can refer to categories or sets of information. Entities can include product and/or service categories, product and/or service names, attributes of products and/or service, collection types of products and/or services or many other types of information. These example entities and are not to be construed as limiting; the entities will vary widely depending on the catalog or the catalog API which has been processed by the conversational platform.

At 208, the conversational platform extracts entity values relating to each entity extracted at 206. Entity values will be entries corresponding to information within the categories or sets of information represented by the entities. For example, an entity can be “product name” and the corresponding entity values will include things like “Company A Tablet PC Model 12345,” “Company B Desktop PC Model 234567,” etc. Another example entity could be “type of computer” with entity values of “tablet,” “laptop,” “server,” and “desktop.” Further examples of entities can include things like “price,” “size,” “color,” or any other descriptive feature or attribute of the products and/or services within the catalog or catalog API. Corresponding entity values can include things like “$0.99 to $9.99,” “$10.00 to $100.00,” “small,” “medium,” “large,” “blue,” “green,” etc. (respectively). These example entities and corresponding entity values are not to be construed as limiting; the entities and corresponding entity values will vary widely depending on the catalog or the catalog API which has been processed by the conversational platform.

For some entity values, the conversational platform can determine there are a closed set of possible options. For example, the conversational platform can determine that for an entity of “shoe size,” there are a fixed number or group of possible sizes such as 6, 6.5, 7, 7.5, . . . 15, 15.5, and 16, and entity values outside this group will not be accepted or will be flagged for review. In some embodiments, the conversational platform can utilize system-wide entity values for known entities such as “shoe size” for the catalogs or catalog APIs of multiple businesses. When providing a user with options for an entity with a closed set of possible options, as will be discussed in further detail regarding method 300 of FIG. 3, infra, the conversational platform can provide a user the full closed list of possible options.

For some entity values, the conversational platform can determine there are an open set of possible options. For example, the conversational platform can determine that for an entity of “price,” there are an infinite or very large number or group of possible prices. Prices can include any combination of dollars, cents, pounds, euros, or any other currency. As such, when providing a user with options for an entity with an open set of possible options, as will be discussed in further detail regarding method 300 of FIG. 3, infra, the conversational platform may not be able to provide a user the full list of possible options, but may instead provide ranges or otherwise limit the options provided.

At 210, the conversational platform enriches the entities and entity values from operations 206 and 208. This enrichment can be performed by the conversational platform by looking up synonym sets or other sources of likeness information to enhance the entities and entity values used by the conversational platform. This process can match the entities and/or entity values contained within the catalog or catalog API with similar names for entities and/or entity values which a user may use when looking for products and/or services offered by the business. For example, a catalog or catalog API may refer to upper body wear as shirts, but not use terms such as blouses, tops, tank tops, t-shirts, or other similar words for upper body wear. The conversational platform can associate the shirt entities and/or entity values with some or all of these similar terms as appropriate, such that a user seeking to buy a blouse will not encounter a catalog of only “shirts” with no matches for their search.

In some embodiments, the conversational platform can also use other catalog instances to enhance the entities and entity values used by the conversational platform. These other catalog instances can include catalogs or catalog APIs provided by other businesses which use similar terminology or have competing products. The conversational platform can match the entities and/or entity values contained within the catalog or catalog API with similar entities and/or entity values used by other catalogs, catalog APIs, or the conversational platform's enrichment of those catalogs or catalog APIs. After the conversational platform enriches the entities and entity values at 210, method 200 ends at 212.

Referring now to FIG. 3, depicted is an example method 300 for assisting a user using a conversational platform, in accordance with embodiments of the present disclosure. The following discussion will refer to method 300 being performed by a conversational platform. It is to be understood that the conversational platform can be implemented by (and, thus, method 300 performed by) a computer, a processor, a memory controller, firmware or software running on a computer system, or other component(s) of a computer system. Method 300 can include more or less operations than those depicted. Method 300 can include operations in different orders than those depicted, including operations occurring simultaneously. Method 300 can use a catalog or catalog API and its extracted and enriched data, such as that resulting from method 200 discussed supra with regards to FIG. 2.

Method 300 starts at 302. At 304, the conversational platform receives a user conversational input. The user conversational input can include a request for a product and/or service. This input can be in the form of natural language or other conversational input. It can be input to the conversational platform in various ways in various embodiments, including typed into a computer device, including a laptop computer, desktop computer, smartphone, or any other device. It could also be input to a device via speech or any other format. The user conversational input can be provided in various levels of detail. An example of a user conversational input is “I would like to buy a blue men's shirt,” or “I am looking to buy a tablet.”

At 306, the conversational platform detects one or more relevant entities and entity values to the input. The conversational platform can detect entities within the conversational input and in some embodiments, can detect that words or phrases in the conversational input are synonyms or otherwise match entities. The conversational platform can also detect entities based upon entity values present in the conversational input. Continuing with the example of “I would like to buy a blue men's shirt,” the conversational platform could detect the entities “department” (from the entity value “men's” corresponding to the entity “department”), “color” (from the entity value “blue” corresponding to the entity “color”), and “catalog-item” (from the entity value “shirt” corresponding to the entity “catalog-item”). Continuing with the example of “I am looking to buy a tablet,” the conversational platform could detect the entity “computer type” (from the entity value “tablet” corresponding to the entity “computer type”). These examples and the specific entity names and entity value names are for example purposes and should not be read as limiting. Many possible conversational inputs, entities, and entity values will exist in various embodiments. In some embodiments, the conversational platform may prompt a user with possible entities or entity values based on their conversational input to confirm their intent or otherwise provide more information to the conversational platform.

At 308, the conversational platform identifies matching products and/or services. The conversational platform can create a query using the entities and/or entity values detected at operation 306 from the user conversational input and can run this query through the catalog or catalog API to identify matching products and/or services. An example query could be the following: “GET/api/item q={catalog-item:“shirt”, color:“blue”, dept:“men's”}. The form and content of the query will vary in embodiments depending on the nature of the catalog or catalog API. The results of the query should consist of the products and/or services which match the detected entities and/or entity values and in some embodiments, may also contain products and/or services which are similar to the detected entities and/or entity values or are otherwise recommended by the catalog, catalog API, or conversational platform. In some embodiments, the results of the query can indicate that there are no matches in the conversational platform which correspond to the user conversational input. The conversational platform can inform the user of this result and can provide recommendations or otherwise assist the user in providing a conversational input which will yield results.

Once the conversational platform receives the results of the query, the conversational platform displays these results to the user at 309. This can occur in various formats in embodiments, including displaying a list of the matching products and/or services on a graphical user interface on a user device, such as the user's laptop computer, desktop computer, smartphone, or other device. The displaying can also include displaying photographs and/or providing other details or information about the matching products and/or services to the user. Instead of, or in addition to, displaying the matches in a list, the conversational platform can display the matches in a table, grid, or any other representation suitable for display to the user. The displaying can be limited to those products and/or services which are capable of fitting on a screen associated with the user's device and may be separated into multiple pages or displays of products and/or services. In some embodiments, the conversational platform may detect the size or resolution of the user's screen and display a number of products and/or services according to the detected size or resolution. The matching products and/or services displayed to the user can be sorted or ranked based on various features including closeness of match, popularity, or any other feature or features of the products and/or services. In some embodiments, a user may be able to select one or more features for the conversational platform to use in sorting the matches.

At 310, the conversational platform can determine if a user has selected one or more products and/or services displayed at operation 309. If the user has selected one or more products and/or services, method 300 proceeds to operation 320.

If at 310, the user has not selected one or more products and/or services, method 300 proceeds to operation 312 to determine if user refinement of the identified and displayed matches is desired. If no user refinement is desired, method 300 ends at 324. A user may decide not to further refine the matching products and/or services for various reasons, including a lack of suitable options or desire to be done shopping. In some embodiments, a user may have an option to quit the conversational platform, input a new conversational input and thereby restart method 300, or other means by which they can exit the conversational platform or terminate their session.

If the user desires refinement of the identified and displayed matches, method 300 proceeds to 314. At 314, the conversational platform assesses one or more attributes of the matching products and/or services to refine. These attributes can be entities which describe one or more of the matching products and/or services. For example, attributes can include “color,” “size,” “price,” etc. The conversational platform can use varying inputs to determine which attribute or attributes to refine in an effort to determine which attribute(s) will most likely lead a user to selection of one or more products and/or services in the fewest number of steps. To this end, the conversational platform can first determine a list of possible attributes of the matching products and/or services to refine. The conversational platform can compute likelihoods for each of the possible attributes that refinement of that attribute will lead to user selection of one or more products and/or services.

In some embodiments, the conversational platform can use the current set of entities and/or entity values, which have been detected from the user's conversational input and compute a likelihood for each possible attribute that the user will make a selection based upon refinement of that attribute. Continuing with the example of: “I would like to buy a blue men's shirt,” and entities and entity values of “catalog-item”:“shirt”, “color”:“blue”, “department”:“men's,” the conversational platform could determine likelihoods that a user with these entities and entity values will make a selection based upon further attributes of “price,” “size,” “fabric,” etc. These likelihoods can be based on various factors including past purchasing information with the same or similar entities and entity values or could be rule based, such as the selection-likelihood is proportional to number of unique products and/or services remaining after refinement based upon each attribute. Such likelihoods could be termed selection-likelihoods_{selection}, or any other designation used by a conversational platform.

In some embodiments, the conversational platform can use interaction logs for some or all of the previous users and their selections (including the refinement of which attributes most often lead to selection of one or more products and/or services). Using these interaction logs, the conversational platform can compute a likelihood for each possible attribute that the user will make a selection based upon refinement of that attribute. Continuing with the blue men's shirt example, the conversational platform can compute likelihoods for attributes such as “price,” “size,” “fabric,” etc. based upon previous users' selection histories with or without regard to the current entities and entity values. Such likelihoods could be termed selection-likelihoodₐₗₗ₋ᵤₛₑᵣₛ, or any other designation used by a conversational platform.

In some embodiments, the conversational platform can use interaction logs for the current user and their selections (including the refinement of which attributes most often lead to selection of one or more products and/or services). If a user has used the conversational platform previously, the conversational platform can compute likelihoods based upon this particular user's selections. If for example, a user often or consistently makes selections when prompted to refine by price, the price attribute could have a higher likelihood. Conversely, if a user has historically not made selections based upon fabric, the conversational platform can compute a lower likelihood for that attribute. Such likelihoods could be termed selection-likelihood_{current-user}, or any other designation used by a conversational platform.

In some embodiments, the conversational platform can use configurations contained within or accompanying the catalog or catalog API in determining likelihoods for attributes. A business may have developed their own process for determining which attributes are most likely of importance to users and provided this information to the conversational platform. The conversational platform can use any such provided information in determining likelihoods that attributes will lead to selections and such likelihoods could be termed selection-likelihood_{catalog-config}, or any other designation used by a conversational platform.

A conversational platform can use one or more of these various selection likelihoods in determining which attribute(s) to select for further refinement. In some embodiments, the conversational platform can compute a weighted average of one or more selection likelihoods to reach a final selection likelihood. For example, a selection-likelihood_{final} can be computed by summing weighted values of selection-likelihood_{selection}, selection-likelihoodₐₗₗ₋ᵤₛₑᵣₛ, selection-likelihood_{current-user}, and selection-likelihood_{catalog-config}. These listed types of selection likelihoods and potential information sources for performing such computations are provided for example purposes only; a conversational platform may use additional types of selection likelihoods or other sources of information in various embodiments.

At 316, the conversational platform provides attribute refinement option(s) to the user. Based on the assessment of attributes to refine at operation 314, the conversation platform can select one or more attributes for user refinement and provide refinement options to the user. The form of these refinement options can vary in embodiments and can depend on the attribute selected. Attributes which correspond to entities with a closed set of entity values (such as discussed above regarding operation 208 of method 200) can be refined by providing the user with a list of the options for entity values, such as in a dropdown menu. For example, a user can be provided with a list of all possible sizes if the selected attribute is “size.” Attributes which correspond to entities with an open set of entity values (such as discussed above regarding operation 208 of method 200) can be refined by providing the user with a list of ranges of entity values or requesting a user input regarding the values. For example, if an attribute to be refined is “price,” a user can be provided with a list of price ranges, a user can be asked to input a desired minimum and maximum price, or a user can be directed to move sliders on a price scale to select prices between two sliders.

At 318, the conversational platform receives the user refinement. The user refinement will vary and depend on the refinement options provided to the user in operation 316. The user refinement can include things such as selections from a list of options, inputting values, or providing other user input to the conversational platform.

Using the user refinement received at 318, the conversational platform can return to operation 308 to identify matches. These matches can be identified using the user refinement received at 318 as well as the user conversational input received at 304. With the new user refinement provided at 318, one or more additional entities and/or entity values can be used by the conversational program in identifying matching products and/or services at 308 and displaying those matches to the user at 309. Method 300 can loop through operations 308 through 318 until the user selects one or more products and/or services, declines to refine the products and/or services further, or otherwise terminates the process.

At 320, the conversational platform can provide cross-sell and/or up-sell recommendations based on the products and/or services selected and the user's interactions with the conversational platform to entice a user to purchase additional and/or more expensive items than that selected. In some embodiments operation 320 is optional. The conversational platform can contain information regarding which products and/or services a business wishes to sell preferentially, which can be presented to users as up-sell options or recommends selling together with other products, which can be presented to users as cross-sell options. This may take the form of collections of items or otherwise grouped items. In some embodiments, these up-sell and/or cross-sell options can be provided or generated using static (or specified) products or services to up-sell and/or cross-sell, i.e. when a user selects a specific product and/or service, another product and/or service is presented to the user as a possible option. In other embodiments, these up-sell and/or cross-sell options can be provided or generated using dynamically (or rule-based) selected products or services to up-sell and/or cross-sell when a user selects a product and/or service which follows a pattern which indicates another product and/or service is appropriate to recommend. In some embodiments, when presenting products or services to up-sell and/or cross-sell, the conversational platform can engage in refinement in a manner similar to operations 308 through 318.

At 322, the conversational platform can receive a final user selection and may facilitate the sale. In embodiments which did not use operation 320 for up-selling and/or cross-selling, the conversational platform can already have the user's final selection as determined in operation 310. In some embodiments, the conversational platform may present full product or service details to the user. In some embodiments, the conversational platform can redirect the user to a website or other service provided by the business which uploaded the catalog or provided the catalog API to complete the sale. In some embodiments, a user can make a purchase directly with the conversational platform and the conversational platform can inform the business of the details of the sale. The conversational platform can engage in taking various forms of information from the user, such as shipping address, payment information, etc. and processing payment via any manner of payment processing. After operation 322, method 300 ends.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for using a catalog driven interactive conversational platform, the method comprising:
receiving, by a computer, a conversational input;
detecting, by the computer and based on the conversational input, relevant entities and relevant entity values, wherein the relevant entities and relevant entity values correspond to entities and entity values extracted from a catalog;
identifying, by the computer and based on the relevant entities and relevant entity values, one or more matching products or services;
displaying, by the computer, the one or more matching products or services;
assessing, by the computer, one or more attributes of the matching products or services for refinement;
providing, by the computer, one or more attribute refinement options based on the assessed one or more attributes;
receiving, by the computer, user refinement in response to providing the one or more attribute refinement options; and
receiving, by the computer, a product or service selection.

2. The method of claim 1, the method further comprising:
processing, by the computer, the catalog;
extracting, by the computer, entities from the catalog; and
extracting, by the computer, entity values from the catalog.

3. The method of claim 2, the method further comprising:
enriching, by the computer, the entities from the catalog; and
enriching, by the computer, the entity values from the catalog.

4. The method of claim 1, wherein the assessing one or more attributes for refinement further comprises:
determining, by the computer, a list of possible attributes of the one or more matching products or services;
computing, by the computer, likelihoods for each of the possible attributes that user refinement of that attribute will lead to a user selection of one or more products or services; and
selecting, by the computer and based on the likelihoods, one or more attributes for which to provide one or more attribute refinement options.

5. The method of claim 4, wherein the computing of likelihoods is based at least in part on the detected relevant entities and relevant entity values.

6. The method of claim 4, wherein the computing of likelihoods is based at least in part on interaction logs for one or more previous users of the catalog driven interactive conversational platform.

7. The method of claim 4, wherein the computing of likelihoods is based at least in part on previous selections made by a user which provided the conversational input.

8. The method of claim 4, wherein the computing of likelihoods is based at least in part on attribute selection configurations relating to the catalog.

9. The method of claim 1, the method further comprising:
providing, by the computer, one or more cross-sell recommendations based on the product or service selection.

10. The method of claim 1, the method further comprising:
providing, by the computer, one or more up-sell recommendations based on the product or service selection.

11. A system for using a catalog driven interactive conversational platform, the system comprising:
one or more processors; and
a memory communicatively coupled to the one or more processors,
wherein the memory comprises instructions which, when executed by the one or more processors, cause the one or more processors to perform a method comprising the steps of:
receiving a conversational input;
detecting, based on the conversational input, relevant entities and relevant entity values, wherein the relevant entities and relevant entity values correspond to entities and entity values extracted from a catalog;
identifying, based on the relevant entities and relevant entity values, one or more matching products or services;
displaying the one or more matching products or services;
assessing one or more attributes of the matching products or services for refinement;
providing one or more attribute refinement options based on the assessed one or more attributes;
receiving user refinement in response to providing the one or more attribute refinement options; and
receiving a product or service selection.

12. The system of claim 11, the method further comprising:
processing the catalog;
extracting entities from the catalog; and
extracting entity values from the catalog.

13. The system of claim 12, the method further comprising:
enriching the entities from the catalog; and
enriching the entity values from the catalog.

14. The system of claim 11, wherein the assessing one or more attributes for refinement further comprises:
determining a list of possible attributes of the one or more matching products or services;
computing likelihoods for each of the possible attributes that user refinement of that attribute will lead to a user selection of one or more products or services; and
selecting, based on the likelihoods, one or more attributes for which to provide one or more attribute refinement options.

15. The system of claim 11, the method further comprising:
providing, by the computer, one or more cross-sell recommendations based on the product or service selection.

16. A computer program product for using a catalog driven interactive conversational platform, the computer program product comprising a computer readable storage medium having program instructions embodied therewith, wherein the computer readable storage medium is not a transitory signal per se, the program instructions executable by a computer to perform a method comprising the steps of:
receiving, by a computer, a conversational input;
detecting, by the computer and based on the conversational input, relevant entities and relevant entity values, wherein the relevant entities and relevant entity values correspond to entities and entity values extracted from a catalog;
identifying, by the computer and based on the relevant entities and relevant entity values, one or more matching products or services;
displaying, by the computer, the one or more matching products or services;
assessing, by the computer, one or more attributes of the matching products or services for refinement;
providing, by the computer, one or more attribute refinement options based on the assessed one or more attributes;
receiving, by the computer, user refinement in response to providing the one or more attribute refinement options; and
receiving, by the computer, a product or service selection.

17. The computer program product of claim 16, the method further comprising:
processing, by the computer, the catalog;
extracting, by the computer, entities from the catalog; and
extracting, by the computer, entity values from the catalog.

18. The computer program product of claim 17, the method further comprising:
enriching, by the computer, the entities from the catalog; and
enriching, by the computer, the entity values from the catalog.

19. The computer program product of claim 16, wherein the assessing one or more attributes for refinement further comprises:
determining, by the computer, a list of possible attributes of the one or more matching products or services;
computing, by the computer, likelihoods for each of the possible attributes that user refinement of that attribute will lead to a user selection of one or more products or services; and
selecting, by the computer and based on the likelihoods, one or more attributes for which to provide one or more attribute refinement options.

20. The computer program product of claim 16, the method further comprising:
providing, by the computer, one or more cross-sell recommendations based on the product or service selection.
